(19) United States
(12) Patent Application Publication
(10) Pub. No.: US 2026/0356517 A1
(43) Pub. Date: Nov. 12, 2026

(54) FPV DRONE CARRIER UAV

(71) Applicant: Oleksandr STEPURA, Kyivska oblast (UA)

(72) Inventors: Oleksandr STEPURA, Kyivska oblast (UA); Volodymyr STEPURA, Kyivska oblast (UA)

(21) Appl. No.: 19/352,818

(22) Filed: Oct. 8, 2025

(30) Foreign Application Priority Data
May 12, 2025 (UA) A 2025 02208

(51) Int. Cl. B64U 80/30; B64U 20/80; B64U 80/25; B64U 80/82; B64U 101/20; B64U 101/31

(52) U.S. Cl. CPC B64U 80/30; B64U 20/80; B64U 80/25; B64U 80/82; B64U 2101/20; B64U 2101/31

(57) ABSTRACT

FPV drone carrier UAV having a self-powered payload platform equipped with a flight control tool and an FPV drone fixation mechanism, and equipped with a real-time video signal relay device arranged on the payload platform and including a system for receiving an analog signal, a system for controlling a received signal, and a system for converting the received signal into a digital data flow, wherein the system for receiving the analog video signal includes an antenna module and a set of analog video signal receivers; the antenna module includes a set of sectoral antennas arranged circumferentially and oriented to overlap adjacent sectors, each of the analog video signal receivers is connected to antennas, and is configured to determine a power level of the video signal arriving at each antenna to which it is connected; the system for controlling the received signal includes a microcontroller that is connected to the analog video signal receivers, and a video switcher that is connected to the microcontroller and to the analog video signal receivers. The microcontroller selects an active sector based on a power level of the video signal, and the system for converting the signal into digital data flow includes a video encoder and a digital radio signal transceiver device.

### CROSS-REFERENCE TO RELATED APPLICATION

This application claims priority to Ukrainian Application No. a 2025 02208, filed May 12, 2025, which is hereby incorporated by reference in its entirety.

### FIELD OF THE INVENTION

The invention relates to the field of unmanned aerial vehicles (UAVs) that act as carriers for other UAVs that imply remote control of the UAV based on a first-person view, i.e., an FPV drone.

### BACKGROUND

Remote-control systems such as, e.g., FPV systems, imply that an FPV drone comprises a video camera, and a video signal is transmitted therefrom to a ground control station for playback on special video glasses or a pilot monitor. In order to control the FPV drone, the signal with remote-control commands is transmitted from the ground control station to the FPV drone.

For example, UAVs being carriers for other UAVs, in particular, FPV drones, are known and described in US20170259918A1 published on Sep. 14, 2017 or in US20190176986A1 published on Jun. 13, 2019. The known carrier UAVs comprise a self-powered platform that is equipped with a flight control tool and a detachable fixation tool for the FPV drone arranged on the platform. Therewith, the FPV drone comprises a transceiver device for data exchange with a remote computer device of a ground control station (a video signal from the FPV drone or remote-control commands from the ground control station). A drawback of this FPV system is a limitation in terms of their data transmission range, since a signal quality depends on a distance that it is transmitted to, as well as on whether there are any obstacles at a signal path. Said drawbacks restrict radius and efficiency of mission accomplishment for the FPV drone relative to the ground control station.

One of the ways to increase the operating range of the FPV system and to reduce influence of the interferences on the signal is real-time relay of the signals. The relay implies reception of the signals by an intermediary device and transmission of the received signals to the ground control station or to the FPV drone (depending on a type of the signal). A UAV that acts as a carrier for this FPV drone may be used for real-time relay of the signals from/to the FPV drone.

A real-time video signal relay device is known and described in UA 49932 U published on May 11, 2010. The relay device comprises a platform for receiving an analog video signal, a system for controlling the received signal, and a system for converting the received signal into a digital data flow. The system for receiving the analog video signal comprises an antenna device and a radio station. The system for controlling the received signal comprises a signal analysis device and a monitoring and control device. The system for converting the received signal into the digital data flow comprises a device for automatic adjustment of a signal power and a radio station. The relay device is arranged on a transport platform being a UAV. The signal to be relayed is transmitted to the antenna device. Then, the signal from the antenna device is transmitted to the radio station. Then, the signal from an output of the radio station is received by the signal analysis device. The signal analysis device analyzes parameters of the received signal and transmits an analysis result to the monitoring and control device. Depending on presence and quality of the signal to be relayed, the monitoring and control device generates a control signal. The generated signal is received by an input of the device for automatic adjustment of the signal power, and from its output, the signal is transmitted to the radio station in order to increase or to reduce the power of the emitted signal to be relayed.

The above-described known real-time video signal relay device allows to increase a transmission range of the signal by increasing the emission power, as well as by changing an altitude of the UAV on which this device is arranged. However, the known device does not solve the problem of a limited communication sector for transmission of the video signal and remote-control commands with 360° circular sector coverage without using several antennas or complex control systems, as well as ensuring stable signal transmission at long distances (5 km and more). Therewith, the increase of the emission power reduces energy efficiency of the UAV on which the relay device is arranged, while the change of the altitude of this UAV is not always possible, e.g., in view of weather conditions, military operations, etc.

### SUMMARY OF THE INVENTION

The claimed invention is based on a task to provide a payload for a carrier UAV that would ensure increase of the operating range of an FPV system by using a real-time video signal relay device.

The posed task is solved by providing an FPV drone carrier UAV, the carrier UAV comprises a self-powered payload platform that is equipped with a flight control tool and an FPV drone fixation mechanism, wherein, according to the invention, the carrier UAV is equipped with a real-time video signal relay device comprising a system for receiving an analog signal, a system for controlling a received signal, and a system for converting the received signal into a digital data flow, wherein the system for receiving the analog video signal comprises an antenna module and a set of analog video signal receivers; the antenna module comprises a set of sectoral antennas that are arranged circumferentially and oriented so as to overlap adjacent sectors, each of the analog video signal receivers is connected to at least two antennas, and each of the analog video signal receivers is configured to determine a power level of the video signal arriving at the antenna to which the analog video signal receiver is connected; the system for controlling the received signal comprises a microcontroller that is connected to each of the analog video signal receivers, and a video switcher that is connected to the microcontroller and to the set of the analog video signal receivers, where the microcontroller is configured to select an active sector based on a power level of the video signal, and the system for converting the signal into the digital data flow comprises a video encoder and a digital radio signal transceiver device.

A technical effect of the invention is an increase of quality and reliability of transmission of the video signal from/to the FPV drone at a long distance by real-time video signal relay via the carrier UAV. Therewith, noises and losses are minimized due to arrangement of the real-time video signal relay device on the carrier UAV and use of the antenna module in this device, the antenna module covers the 360° circular sector and a video signal selection algorithm based on the power level that is executed by means of the microcontroller connected to the set of the analog video signal receivers and to the video switcher.

According to one of embodiments of the invention, the antenna module of the video signal real-time relay device comprises an omnidirectional short-range antenna that is connected to one of the analog video signal receivers. The omnidirectional short-range antenna covers a blind zone provided by the set of the sectoral antennas.

According to another embodiment of the invention, the set of the sectoral antennas together with the omnidirectional short-range antenna that are comprised in the real-time video signal relay device are oriented so as to cover the circular sector being 360°, thereby allowing to achieve a maximum coverage for the video signal reception.

According to a further embodiment of the invention, each of the sectoral antennas comprised in the real-time video signal relay device is directed downwards to the ground at an angle between 50° and 70° with respect to the horizontal, thereby achieving a seamless real-time video signal relay at a distance of up to 8-10 km from a video signal source within the circular sector of 360°.

According to a further embodiment of the invention, each of the analog video signal receivers comprised in the real-time video signal relay device is configured to support at least two antennas comprised in the antenna module, thereby allowing to optimize a hardware structure of the system for receiving the analog video signal in order to ensure 360° coverage of a video signal receiving area.

According to a further embodiment of the invention, a number of the antennas within the antenna module comprised in the real-time video signal relay device is a multiple of a number of the analog video signal receivers. This further optimizes the hardware structure of the system for receiving the analog video signal.

According to a further embodiment of the invention, the FPV drone fixation mechanism is secured on the payload platform that is equipped with an FPV drone power source for maintaining its charge during fixation of the FPV drone on the payload platform, thereby ensuring additional powering of the FPV drone and increasing efficiency of the mission accomplishment by the FPV drone.

The digital radio signal transceiver device comprised in the real-time video signal relay device is configured to transmit the video signal to a remote computer device of a ground control station. To this end, the remote computer device of the ground control station is connected to a video signal playback tool and configured to visually display a sectoral diagram of power levels of the signal received by the microcontroller from the analog video signal receivers on the video signal playback tool. The remote computer device of the ground control station is further configured to transmit remote-control commands to the microcontroller by means of the digital radio signal transceiver device via a dedicated communication channel that is synchronized with the video signal. This increases control reliability of the relay device, in particular, change of a frequency of receiving the signal, selecting the sector with the best level of the radio signal or starting an autonomous search for the sector with the best level of the radio signal. In particular, when the video signal real-time relay device is used for an FPV system that will be described hereinafter, this increases a mission accomplishment efficiency, since it allows an operator to understand in which sector the FPV drone is located relative to the carrier UAV.

### BRIEF DESCRIPTION OF THE DRAWINGS

An exemplary embodiment of the inventive UAV carrier for the FPV drone that is equipped with the real-time video signal delay device is provided herein below. The provided example is illustrated in the Figures, where:

FIG. 1 illustrates a side view of the real-time video signal relay device mounted on the carrier UAV.

FIG. 2 illustrates a bottom view of the real-time video signal relay device mounted on the carrier UAV.

FIG. 3 illustrates a schematic diagram of the real-time video signal relay device.

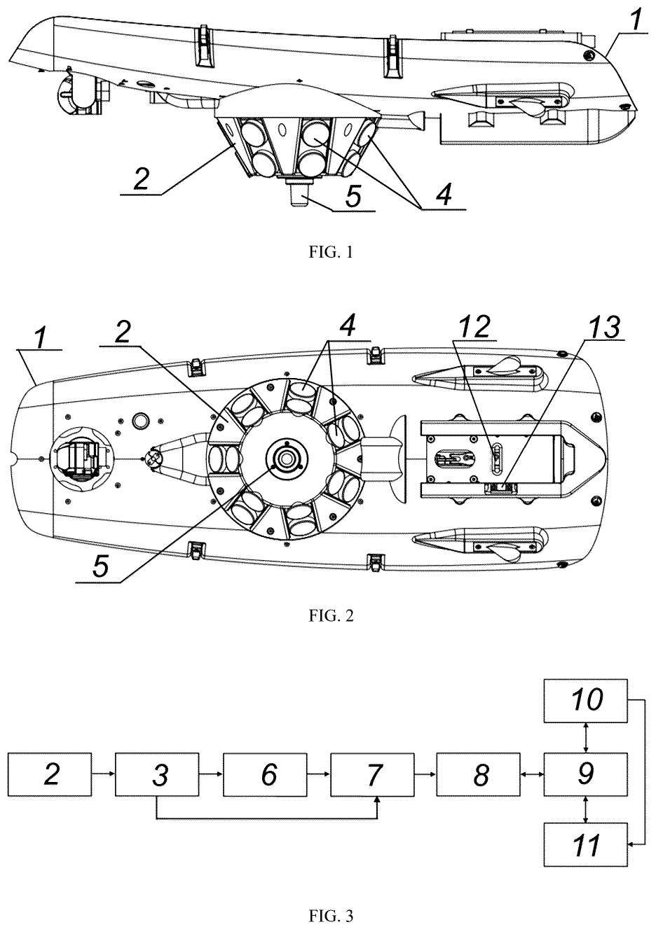

FIGS. 1 and 2 illustrate the carrier UAV partially in a location of the real-time video signal relay device on the payload platform.

FIGS. 1-3 use the following designations
1—the payload platform;
2—the antenna module;
3—the analog video signal receiver;
4—the sectoral antenna;
5—the omnidirectional short-range antenna;
6—the microcontroller;
7—the video switcher;
8—the video encoder;
9—the digital radio signal transceiver device;
10—the remote computer device of the ground control station;
11—the video signal playback tool;
12—the FPV drone fixation mechanism;
13—a power source connector of the FPV drone.

Figures that illustrate the claimed invention and the disclosed specific exemplary embodiments do not limit the scope of claims in any way, rather they only explain contain aspects of the invention.

### IMPLEMENTATION POSSIBILITY

FIGS. 1 and 2 illustrate a real-time video signal relay device that is arranged on a useful load platform (1) of an FPV drone carrier UAV. This self-powered payload platform (1) is equipped with a flight control tool and an FPV drone fixation mechanism (12). The payload platform (1) is equipped with an FPV drone power source for maintaining its charge during fixation on the payload platform (1). A power source connector (13) of the FPV drone is arranged outside the payload platform (1). Herein, the payload platform (1) shall mean a removable part of a housing of the carrier UAV, e.g., an aircraft-type UAV, that is suitable for arranging the payload, including the real-time video signal relay device.

FIG. 3 illustrates a schematic diagram of a real-time video signal relay device that comprises a system for receiving an analog video signal, a system for controlling a received signal, and a system for converting the received signal into a digital data flow.

The system for receiving the analog video signal comprises an antenna module (2) and a set of analog video signal receivers (3). FIGS. 1 and 2 illustrate an exemplary embodiment of the real-time video signal relay device, where its antenna module (2) comprises a plurality of, here a set of seven, sectoral antennas (4) and an omnidirectional short-range antenna (5). As illustrated in FIG. 2, the sectoral antennas (4) are arranged circumferentially and, together with the omnidirectional short-range antenna, cover a circular sector of 360°. Therewith, the sectoral antennas (4) are oriented so as to overlap adjacent circular sectors. According to the example, the antenna module (2) has a shape of a truncated inverted cone having a side surface with the sectoral antennas (4) arranged thereon, the sectoral antennas are directed downwards towards the ground at an angle of between 50° and 70° with respect to the horizontal, and an optimal angle is 60°. The omnidirectional short-range antenna (5) is arranged in a central part of the antenna module (2) at the truncation of the inverted cone. Each of the analog video signal receivers (3) is connected to two antennas. According to the exemplary embodiment illustrated in FIGS. 1 and 2, the system for receiving the analog video signal comprises a plurality of, here four, analog video signal receivers (3), and two antennas are connected to each of them: seven sectoral antennas (4) and the omnidirectional short-range antenna (5). The sectoral antennas (4) are connected as follows: two adjacent (first and second) sectoral antennas (4) are connected to the first analog video signal receiver (3); the third and fourth sectoral antennas (4) that are circumferentially arranged after them are connected to the second analog video signal receiver (3); the fifth and sixth sectoral antennas (4) that are circumferentially arranged after them are connected to the third analog video signal receiver (3), the seventh sectoral antenna (4) and the omnidirectional short-range antenna (5) are connected to the fourth analog video signal receiver (3). Therefore, the first and second sectoral antennas (4) form a single circumferential sector, the third and fourth sectoral antennas (4) form a second circumferential sector adjacent thereto, the fifth and sixth sectoral antennas (4) form a third circumferential sector adjacent thereto, and the seventh sectoral antenna (4) together with the omnidirectional short-range antenna (5) form a fourth circumferential sector. These circumferential sectors together form a circumferential sector of 360°. The sectoral antennas (4) are directional (directed) antennas that are oriented in a certain direction for emitting or receiving a major part of the power, thereby allowing to increase efficiency and to reduce an influence of interferences. The omnidirectional short-range antenna (5) covers a blind zone provided by the set of the sectoral antennas (4). Each of the analog video signal receivers (3) is configured to determine a power level of the signal that is transmitted to the sectoral antenna (4) to which the analog video signal receiver (3) is connected. The analog video signal receiver (3) may be a VRX video receiver that meets the above-mentioned requirements.

According to FIG. 3, the system for controlling the receiving signal comprises a microcontroller (6) and a video switcher (7). The microcontroller (6) is connected to each of the analog video signal receivers (3). The microcontroller (6) is configured to process a reading of the power level of the signal received from the analog video signal receivers (3) and to select an active sector based on the signal power level. To this end, the microcontroller (6) is programmed to select the active sector based on the signal power level. Also, the microcontroller (6) is programmed to store IDs of each of the analog video signal receivers (3). For example, it may be a number of the analog video signal receiver (3) or another similar ID. The microcontroller (6) is connected to the video switcher (7) in order to control it. The video switcher (7) is intended to switch the video signal received from the analog video signal receivers (3).

According to FIG. 3, the system for converting the received signal into the digital data flow comprises a video encoder (8) and a digital radio signal transceiver device (9). The video encoder (8) is intended to convert the analog video signal into the digital data flow. The digital radio signal transceiver device (9) is connected to the video encoder (8) and configured to transmit the digital radio signal to a distance of up to 150 km.

An exemplary use of the above-described real-time video signal relay device for an FPV system is provided hereinafter. The FPV system comprises a self-powered carrier UAV and an FPV drone arranged on a useful load platform of the carrier UAV. According to the example, the real-time video signal relay device is arranged on the useful load platform of the carrier UAV.

Remote control of the FPV drone is performed from a ground control station that implies use of a remote computer device of the ground control station (10). The remote computer device of the ground control station (10) is equipped with a desktop application intended to control the video signal relay in real time via a configuration and monitoring interface. The digital radio signal transceiver device (9) is configured to transmit the video signal to the remote computer device of the ground control station (10). The remote computer device of the ground control station (10) is configured to transmit remote-control commands to the microcontroller (6) by means of the digital radio signal transceiver device (9) via a dedicated communication channel that is synchronized with the video signal. Therewith, the digital radio signal transceiver device (9) is configured to transmit the video signal to a video signal playback tool (11) simultaneously with the transmission of the video signal to the remote computer device of the ground control station (10). The remote computer device of the ground control station (10) is configured to visually display a sectoral diagram of the power levels of the signal received by the microcontroller (6) from the analog video signal receivers (3) at the playback tool (11).

The above-described real-time video signal relay device comprised in the FPV system is used in the following way. The carrier UAV delivers the FPV drone to a mission accomplishment area. After the FPV drone is released from the FPV drone fixation mechanism (12), the FPV drone is disconnected from the payload platform (1) and flies on its own to a mission accomplishment location that may be located at a distance of up to 150 km from the ground control station. Therewith, data exchange between the FPV drone and the ground control station is performed via the real-time video signal relay device. To this end, each analog video signal receiver (3) receives the signal from two antennas to which it is connected and determines the best power level of the video signal. All the analog video signal receivers (3) transmit data about the power level of the video signal to the microcontroller (6). The microcontroller (6) analyzes the received data and selects the video signal having the best power level. The selected video signal is transmitted to the video encoder (8) via the video switcher (7). The video encoder (8) converts the analog signal into digital data flow (being a network flow). The digital data flow with the video signal is received by the digital radio signal transceiver device (9) that, in turn, transmits the signal to the remote computer device of the ground control station (10).

The operator controls the real-time video signal relay device via the remote computer device of the ground control station (10) by means of the desktop application. In particular, the interface of the desktop application allows to perform the following operations: selection of a frequency for receiving the video signal, monitoring the power level of the video signal in real time for each analog video signal receiver (3), display of the sectoral diagram of the signal levels, automatic or manual switch of the active sectoral antenna (4), automatic selection of the active sector having the highest power level of the video signal.

The microcontroller (6) plays a main role in collecting and processing the data from the analog video signal receivers (3). The desktop application of the remote computer device of the ground control station (10) and the microcontroller (6) interact by means of the digital radio signal transceiver device (9) via the dedicated communication channel that is synchronized with the video signal. To this end, the microcontroller (6) receives values of the power level of the video signal from the analog video signal receivers (3) and processes them. The desktop application sends a request for the video signal power level values via the command ‘GET_RSSI’. The operator can manually change the frequency of receiving the video signal by sending the command ‘SET_FREQ’. Based on the received data about the video signal power level, the microcontroller (6) automatically controls the video switcher (7) to select the video signal having the highest power level for its subsequent relay to the video signal playback tool (11). The video signal is displayed by means of the video signal playback tool (11), in particular, the desktop application of the remote computer device of the ground control station (10) forms a sectoral diagram for displaying a direction of receiving the video signal having the highest power level. This allows to determine a source of the video signal of the highest quality and to perform correction of the settings of the real-time video signal relay.

Integration of the microcontroller (6), the sets of the analog video signal receivers (3), and the desktop application on the remote computer device of the ground control station (10) increases the reliability of controlling the reception of the high-quality video signal from the FPV drone. Owing to the real-time monitoring of the power level of the video signal and to the automatic selection of the active sector based on the power level for the video signal relay to the ground control station, the inventive relay device allows to avoid noises and to enhance the data exchange between the FPV drone and the ground control station at a high distance between them.

The above-described carrier UAV may be used for military, rescue, research, and commercial purposes, where it is important to ensure high-quality communication at long distances and precision of the video surveillance.

Therefore, the claimed invention allows to obtain the payload on the carrier UAV that ensures increase of the operating range of the FPV systems by using the real-time video signal relay device.

1. An FPV drone carrier UAV, comprising a self-powered payload platform that is equipped with a flight control tool and an FPV drone fixation mechanism, wherein the carrier UAV is equipped with a real-time video signal relay device comprising a system for receiving an analog signal, a system for controlling a received signal, and a system for converting the received signal into a digital data flow, wherein the system for receiving the analog video signal comprises an antenna module and a set of analog video signal receivers, the antenna module comprises a set of sectoral antennas that are arranged circumferentially and oriented so as to overlap adjacent sectors, each of the analog video signal receivers is connected to two antennas, and each of the analog video signal receivers is configured to determine a power level of the video signal arriving at each antenna to which the analog video signal receiver is connected; the system for controlling the received signal comprises a microcontroller that is connected to each of the analog video signal receivers, and a video switcher that is connected to the microcontroller and to the set of the analog video signal receivers, where the microcontroller is configured to select an active sector based on a power level of the video signal, and the system for converting the signal into the digital data flow comprises a video encoder and a digital radio signal transceiver device.

2. The carrier UAV according to claim 1, wherein the antenna module of the real-time video signal relay device comprises an omnidirectional short-range antenna that is connected to one of the analog video signal receivers.

3. The carrier UAV according to claim 2, wherein the set of the sectoral antennas together with the omnidirectional short-range antenna that are comprised in the real-time video signal relay device are oriented so as to cover a circumferential sector of 360°.

4. The carrier UAV according to claim 1, wherein each sectoral antenna that is comprised in the real-time video signal relay device is directed downwards towards the ground at an angle of between 50° and 70° with respect to the horizontal.

5. The carrier UAV according to claim 1, wherein each of the analog video signal receivers that is comprised in the real-time video signal relay device is configured to support at least two antennas comprised in the antenna module.

6. The carrier UAV according to claim 1, wherein a number of the antennas within the antenna module of the real-time video signal relay device is a multiple of a number of the analog video signal receivers.

7. The carrier UAV according to claim 1, wherein the FPV drone fixation mechanism is secured on the payload platform that is equipped with an FPV drone power source configured to maintain its charge during fixation on the payload platform.
